(19) United States
(12) Patent Application Publication
(10) Pub. No.: US 2015/0046830 A1
(43) Pub. Date: Feb. 12, 2015

(54) Methods, Device and Social Network Manager for Enabling Interaction with Another Device

(71) Applicants: Joakim Formo, Akersberga (SE); Marcus Gårdman, Skarholmen (SE); Farjola Peco, Solna (SE)

(72) Inventors: Joakim Formo, Akersberga (SE); Marcus Gårdman, Skarholmen (SE); Farjola Peco, Solna (SE)

(73) Assignee: TELEFONAKTIEBOLAGET L M ERICSSON (PUBL), Stockholm (SE)

(21) Appl. No.: 14/385,682

(22) PCT Filed: Mar. 19, 2012
(86) PCT No.: PCT/SE2012/050300

§ 371 Date: Sep. 16, 2014

(51) Int. Cl. H04L 29/08; H04W 76/02; H04L 29/06

(52) U.S. Cl. CPC H04L 67/025; H04L 65/403; H04W 76/02
USPC 715/740

(57) ABSTRACT

Methods and apparatuses for enabling a first device (100) to interact with a second device (102) for usage of functionality in the second device. When the first device detects (1:1) that it is present within a limited distance (102a) from the second device by means of a local wireless link, the first device sends (1:2) a request to a social network manager (104) to establish a temporary trusted connection with the second device. The first device then obtains (1:5) profile information regarding the second device from the social network manager based on the trusted connection, and adapts (1:6) its user interface based on the profile information. A user is then able to execute the interaction between the first and second devices via the social network manager by means of the adapted user interface.

### TECHNICAL FIELD

The present disclosure relates generally to a first device and a social network manager and methods therein, for enabling interaction with a second device for usage of functionality in the second device.

### BACKGROUND

Recently, techniques have been developed where the concept of social networks is employed in communication systems with various different communication devices which can interact and/or share information based on a “social relation” between the devices. In this field, the devices are treated as individuals or system entities having their own profiles relating to various functions, characteristics and features in the devices. It is also possible for the devices to become “friends”, i.e. by creating a trusted connection or relation in a central node configured for managing the social network, which enables the devices to interact in some controlled manner, as similar to what humans can do by means of internet-based social networks such as e.g. Facebook. US 2011/0161478 A1 discloses how friendship relationships between networked objects, e.g. devices, can be managed in the context of a social network.

In the following description, the term “device” is used to represent any terminal, user equipment, sensor, etc. which is capable of communication with a communications network and can be registered with a central social network manager. Some non-limiting examples of such devices that can be used in this context include mobile phones, laptop computers, tablets, television sets, media players, game consoles, as well as various sensors and counters. Further, the term “social network manager” is used here for a centralized function or node where the social network and its “members” are handled, including registration of devices and maintenance of trusted connections between devices.

When a device is registered with the social network manager, the profile of the device is stored which includes a device identification that may be a network address such as a Medium Access Control (MAC) address, Internet Protocol (IP) address, or the like. Further, a social identity is also assigned to the device which is valid in the social network. The social identities are mainly used for identifying and accessing devices as entities or members of the social network and to enable interaction between the devices in the social network, where the interaction may be handled and controlled by the social network manager.

A social relation can thus be created for two devices by establishing a trusted connection for the two devices in the social network manager, which enables the devices to share their profiles, or at least selected parts thereof, and to interact in some way via the social network manager. To establish such a trusted connection for the two devices, it is required that a user of one of the devices explicitly requests for a trusted connection, or “friendship”, and that the user of the opposite device accepts the connection in response to the request.

Then, the trusted connection can be established in the social network manager and the devices can access certain information from the respective profiles or interact by controlling functionalities across the devices, and so forth. For example, the user of one device may want to utilize some functionality of the opposite device e.g. to stream media to or from the opposite device. Such operations can thus be accomplished by means of the social network manager provided that a trusted connection has been established therein.

However, this procedure of requesting friendship and obtaining acceptance is sometimes perceived by the device users as quite laborious and time consuming, e.g. when waiting for a response from the opposite user, such that the users may refrain from performing the procedure. In particular, if just an immediate one-off interaction is desired between two devices to execute some functionality, the effort of establishing a trusted connection in the social network manager may not be motivated. It is thus a problem that the above-described conventional procedure of establishing a trusted connection for enabling device interaction is often too much of a hurdle restraining device users from utilizing each other's functionalities and/or sharing information and media by means of their devices. This is of course a drawback for the users but also for network operators and service providers due to missed network traffic and service usage.

### SUMMARY

It is an object of the invention to address at least some of the problems and issues outlined above. It is possible to achieve these objects and others by using a device and a social network manager and methods therein as defined in the attached independent claims.

According to one aspect, a method is provided in a first device for enabling interaction with a second device for usage of functionality in the second device. In this method, the first device sends a request to a social network manager to establish a temporary trusted connection with the second device, when detecting that the first device is present within a limited distance from the second device that allows communication by means of a local wireless link. The first device then obtains profile information regarding the second device from the social network manager based on the temporary trusted connection, and adapts a user interface of the first device based on the obtained profile information. Thereby, a user is enabled to execute the interaction between the first and second devices via the social network manager by means of the adapted user interface.

According to another aspect, a first device is provided which is configured to enable interaction with a second device for usage of functionality in the second device. The first device comprises a detecting unit configured to detect proximity to other devices, and a communication unit configured to send a request to a social network manager to establish a temporary trusted connection with the second device, when the detecting unit detects that the first device is present within a limited distance from the second device that allows communication by means of a local wireless link. The communication unit is further configured to obtain profile information regarding the second device from the social network manager based on the temporary trusted connection. The first device also comprises an adapting unit configured to adapt a user interface of the first device based on the obtained profile information, thereby enabling a user to execute the interaction between the first and second devices via the social network manager by means of the adapted user interface.

By using the above method and first device, respectively, no manual actions are needed from the device users for establishing a trusted connection that allows two closely located devices to interact such that functionality in one device can be controlled and used from another device.

The above method and first device may be configured and implemented according to different optional embodiments. In some possible embodiments, the local wireless link may be based on any of: Bluetooth, RFID and NFC, depending on what type of local communication is available in the devices. The request to establish the temporary trusted connection with the second device may comprise a request for a social identity of the second device, and in that case the profile information may be obtained from the social network manager based on the social identity of the second device. In this way, the profile information can be easily retrieved by the social network manager.

If the user interface comprises a screen, the user interface may be adapted by displaying at least a part of the obtained profile information on the screen. The profile information may comprise a control panel that can be used to control functionality of the second device, and adapting the user interface comprises displaying the control panel on the screen. In that case, it would be easy and convenient for the user to use the first device as a “remote control” to control the second device's functionality.

Further, the profile information may comprise a network address of a web page, and the user interface of the user equipment may in that case be adapted by directing a web browser in the user equipment to use the web page as a start page in the user interface. This can be used as a helpful mechanism e.g. to convey relevant and interesting information to the first device user when entering a certain location. Further, the first device may send a notification to the social network manager when detecting that the local wireless link has been lost, to trigger release of the temporary trusted connection. Thereby, the trusted connection will only be valid and useful as long as the devices are together.

According to another aspect, a method is provided in a social network manager for enabling interaction between a first device and a second device for usage of functionality in the second device. In this method, the social network manager receives a request from the first device to establish a temporary trusted connection with the second device, when the first device has detected to be present within a limited distance from the second device that allows communication by means of a local wireless link. The social network manager then establishes a temporary trusted connection between the first and second devices if the first and second devices have been registered with the social network manager, and sends profile information regarding the second device to the first device based on the temporary trusted connection. Thereby, adaptation of a user interface of the first device can be made based on the sent profile information, and further a user is enabled to execute the interaction between the first and second devices via the social network manager by means of the adapted user interface.

According to another aspect, a social network manager is provided which is configured to enable interaction between a first device and a second device for usage of functionality in the second device. The social network manager comprises a communication unit configured to receive a request from the first device to establish a temporary trusted connection with the second device, when the first device has detected to be present within a limited distance from the second device that allows communication by means of a local wireless link. The social network manager also comprises a logic unit configured to establish a temporary trusted connection between the first and second devices if the first and second devices have been registered with the social network manager. The communication unit is further configured to send profile information regarding the second device to the first device based on the temporary trusted connection, thereby enabling adaptation of a user interface of the first device based on the sent profile information, and further enabling a user to execute the interaction between the first and second devices via the social network manager by means of the adapted user interface.

The latter method and social network manager may be configured and implemented according to different optional embodiments. In one possible embodiment, the first and second devices may have been registered with the social network manager by storing social identities of the first and second devices together with their profiles in a database. In that case, the request to establish the temporary trusted connection with the second device may comprise a request for the social identity of the second device, and the profile information may be sent to the first device in response to a profile request referring to the social identity of the second device. Further, the temporary trusted connection may be released when the social network manager receives a notification from the first device indicating that the local wireless link has been lost.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a communication scenario illustrating how a first device can be automatically enabled to interact with a second device, according to some possible embodiments.

FIGS. 2a and 2b are flow charts illustrating actions in a first device and in a social network manager, according to further possible embodiments.

FIG. 3 is a signalling diagram illustrating an example of a procedure when the solution is used, according to further possible embodiments.

FIG. 4 is a block diagram illustrating a first device and a social network manager in more detail, according to further possible embodiments.

### DETAILED DESCRIPTION

Briefly described, a solution is provided to facilitate for a user of a first device to use functionality in a second device by eliminating the need for manually requesting friendship and obtaining acceptance from the user or owner of the second device. In this solution, the first device instead automatically initiates creation of a trusted connection in a social network manager when detecting that it is close enough to the second device to establish a local wireless link directly between the two devices. For example, the first device may be a mobile phone and the second device may be a television set in a room visited by the mobile phone user who may want the possibility to control the television set from the first device in some way e.g. setting the volume or pushing a video clip to be viewed on the television set. This solution can thus be automatically triggered as soon as the first device approaches the second device, assuming that interaction between the devices and usage of functionality in the second device may become desirable when they are close together.

The local wireless link may be based on Bluetooth, Near Field Communication (NFC), Radio Frequency Identification (RFID), or any other useful wireless signalling mechanism over a short distance. In this type of short-range communication, the devices emit radio waves or signals that can be detected by an opposite device within proximity, and the two devices typically exchange some kind of device identifications such as a device-specific code or signal. For example, a Medium Access Control (MAC) address, an Internet Protocol (IP) address or an RFID code may be used as device identification in this context, although the solution is not limited to these examples.

When receiving a request, which could be an explicit or implicit request, from the first device to establish a temporary trusted connection with the second device, the social network manager checks in a database if both devices have been registered with the social network manager as members of a social network or the like. The database is maintained by the social network manager and basically contains an entry for each registered device including a profile and a mapping between a device identification and a social identity that has been assigned to the device at registration. The profile may comprise information relating to various functions, characteristics and features in the device.

Trusted connections between devices may also be registered in the database, and if the social network manager determines that both of the above first and second devices have been registered in the database as members of the social network, a temporary trusted connection is established, i.e. registered, in the database by the social network manager. The trusted connection may be maintained as long as the local wireless link is continued.

To make interaction between the two devices possible, the social network manager also sends profile information regarding the second device to the first device based on the established temporary trusted connection, e.g. upon request from the first device. The first device then automatically adapts its user interface based on the obtained profile information, such that the first device user is able to execute interaction between the first and second devices via the social network manager by means of the adapted user interface. The user interface may be adapted in different possible ways within the scope of this solution, and some examples will be described later on.

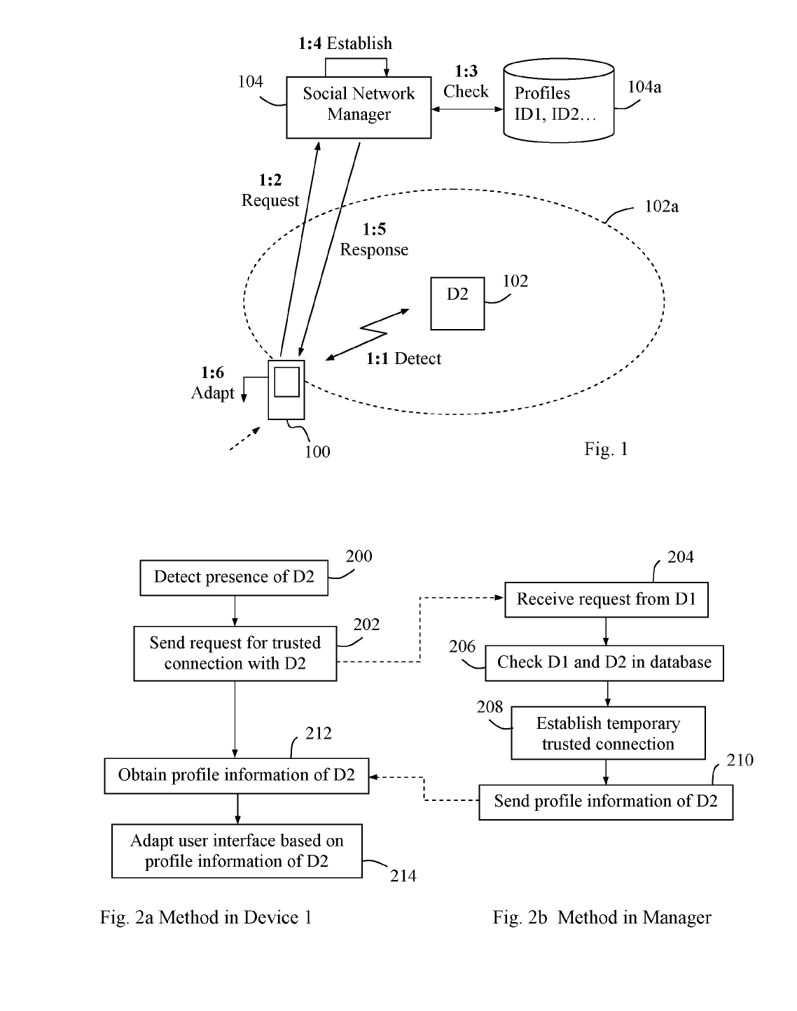

First, the solution will be outlined with reference to an example in the communication scenario shown in FIG. 1 involving a first device 100, a second device 102 and a social network manager 104, the latter maintaining a database 104a with registered devices and their profiles as described above. To mention some non-limiting examples, the first device 100 may be a portable user equipment such as a mobile phone, a tablet or a laptop computer carried by the user, while the second device 102 may be a media player, a television set, a camera or a Personal Computer (PC), whichever having functionality that may be desirable to use for the first device user. The database 104a may be considered more or less as a part of the social network manager 104.

When the first device 100 approaches the second device 102, as indicated by a dashed arrow, it comes within a limited distance 102a from device 102 that allows communication by means of a local wireless link. At this point, the first device 100 detects that it is present within this distance 102a, which may be referred to as “proximity detection” basically when being close enough to detect signals emitted from device 102, as shown by an action 1:1. The devices 100 and 102 also detect their device identifications over the local wireless link, which is common for such short-range communications as described above.

In order to make interaction and control of functionality in the second device 102 possible, the above proximity detection triggers the first device 100 to automatically make a request to the social network manager 104, as shown by another action 1:2, to initiate and establish a temporary trusted connection with the second device 102. This request refers to the device identification of device 102 detected by device 100 in action 1:1, and also contains the device identification of the requesting device 100. As indicated above, the request may be explicit or implicit, and in the latter case it may comprise a request for a social identity of the second device 102 which the first device can use as a reference for obtaining profile information regarding device 102 from the social network manager 104.

When receiving the request from device 100 in action 1:2, the social network manager 104 checks in the database 104a if the first and second devices 100, 102 have been registered with the social network manager as members of the social network, in a further action 1:3. If so, the social network manager 104 establishes a temporary trusted connection between the first and second devices, in a further action 1:4. Establishing the trusted connection may include registering the trusted connection in the database 104a as well.

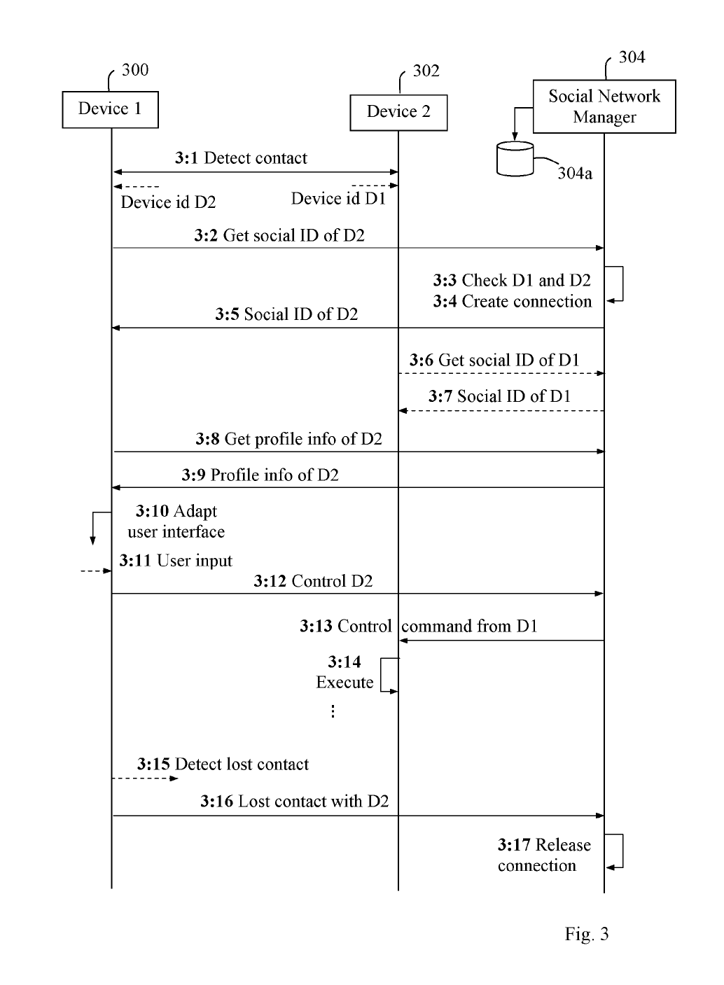

Based on the established temporary trusted connection, the social network manager 104 further sends a response to the first device 100 at some point in an action 1:5, containing profile information regarding the second device 102. The response with profile information may be sent after receiving an additional request for the profile information, not shown in this example, which the first device 100 may send to the manager 104 referring to the social identity of device 102 received previously. The request—response dialogue schematically illustrated by actions 1:2 and 1:5 may thus involve more than one pair of request/response messages, depending on the implementation. An example of such a procedure will be described later on with reference to FIG. 3.

A final action 1:6 illustrates that the first device 100 adapts its user interface based on the obtained profile information of device 102. Thereby, the user of device 100 is enabled to execute the interaction between the first and second devices via the social network manager 104 by using the adapted user interface in some way, which will be described in more detail later on with reference to FIG. 3.

For example, the user interface in a device typically comprises a display screen and in that case the user interface may be adapted by displaying the obtained profile information of device 102, or at least a part thereof, on the screen in a suitable manner. The user is then able to use the displayed information for controlling the second device 102. The profile information may further comprise a control panel that can be used to control functionality of the second device, and the user interface can be adapted by displaying the control panel on the screen for the user to operate or otherwise use. Such a control panel may include controls for adjusting various functionality parameters such a volume, bass/treble, brightness, contrast, etc. on a television set or a media player. The control panel may further include controls for downloading or streaming media to or from the first device. Further non-limiting examples include media rendering capabilities such as play, stop, pause, record, or some vending machine functionality such as item selection and purchase commands, or device power control such as on/off, sleep mode or reboot, or camera functionality such as take picture, etc.

In another example, the profile information may comprise a network address of a web page, and in that case the user interface may be adapted by directing a web browser in the device 100 to display this web page on the user interface, e.g. as a start page when the web browser is activated. This can be utilized such that the web page may disclose information about a restaurant, shop, museum or other premises currently visited by the first device user. Such functionality can be accomplished by having a second device in the premises to interact with any “first” device that enters the premises, in order to provide useful information to the first device user in a convenient and automatic manner.

An advantage with the above-described solution is thus that the user interface can be automatically and rapidly adapted on the first device whenever it comes near the second device, without requiring any human actions for establishing a trusted connection at the social network manager to allow the interaction. This enables the user to use functionality of the second device in some way, which is not limited to the examples described here and the practician is able to implement this solution in any desirable manner.

As said above, the established trusted connection is only temporary and should be released at some point. For example, when the first device detects that the local wireless link with the second device has been lost, such as when the first device has moved away, a notification may be automatically sent from the first device to the social network manager to trigger release of the temporary trusted connection. Alternatively, the trusted connection may be maintained by the social network manager for a preset period of time after which the connection is released automatically.

A procedure of how a first device, e.g. device 100 in FIG. 1, can act to enable interaction with a second device, e.g. device 102 in FIG. 1, for usage of functionality in the second device, will now be described with reference to the flow chart in FIG. 2a. In addition, a matching procedure executed in a social network manager, e.g. the manager 104 in FIG. 1, will also be described in parallel and with reference to the flow chart in FIG. 2b. It is assumed that both devices have been registered as members of a social network in the social network manager, thus having been assigned respective social identities and registered their profiles, which information may be maintained in a database at the social network manager, as described above.

In a first action 200 shown in FIG. 2a, the first device “D1” detects that it is present within a limited distance from the second device “D2” that allows communication by means of a local wireless link, which basically corresponds to action 1:1 in FIG. 1. The first device D1 then sends a request to the social network manager upon the above detection, in a next action 202, to establish a temporary trusted connection with the second device, which basically corresponds to action 1:2 in FIG. 1.

An action 204 in FIG. 2b illustrates that this request is received by the social network manager. In a further action 206, the social network manager checks, e.g. in the database, e.g. database 104a in FIG. 1, that both devices D1 and D2 are registered as members in the social network, which basically corresponds to action 1:3 in FIG. 1. In a further action 208, the social network manager establishes a temporary trusted connection between the first and second devices if they have been registered with the social network manager, which basically corresponds to action 1:4 in FIG. 1.

The social network manager then sends profile information regarding the second device to the first device based on the temporary trusted connection, in an action 210 which basically corresponds to action 1:5 in FIG. 1, to enable adaptation of a user interface of the first device based on the sent profile information. To perform this action, the social network manager may retrieve the profile information from the database. A filtering function or the like may be applied here such that not all information in the stored profile is sent, but only a selected part thereof which may have been predetermined by the second device user or owner. An action 212 in FIG. 2a illustrates that this profile information is received by the first device.

A final shown action 214 illustrates that the first device adapts a user interface of the first device based on the obtained profile information of device D2, thereby enabling a user to execute the interaction between the first and second devices via the social network manager by means of the adapted user interface.

An example of a more detailed procedure when the solution is used, will now be described with reference to the signalling diagram in FIG. 3. As in the above examples, this procedure involves a first device 300, a second device 302 and a social network manager 304, coupled to or comprising a database 304a storing registered devices and their profiles. In a first shown action 3:1, the devices 300 and 302 are located mutually close enough to detect contact by means of a local wireless link, which may be based on Bluetooth, NFC, RFID or similar. The devices also exchange their device identifications denoted “id D1” and “id D2”, e.g. in the form of MAC address, IP address or RFID code, over the local link.

This proximity detection of action 3:1 triggers the first device 300 to send a request to the manager 304, in an action 3.2, that effectively initiates the establishment of a trusted connection with the second device 302. In this example, the request can be seen as an “implicit” request for the trusted connection in the form of a request for the social identity of the second device 302, here denoted “Get social ID of D2”. In a following action 3:3, the social network manager 304 checks and determines that both devices 300 and 302 are registered in database 304a as members of the social network, and creates or establishes a temporary trusted connection in another action 3:4. The social network manager 304 then sends the requested social identity of the second device 302, as retrieved from the database 304a, to device 300 in an action 3:5.

It is also possible that the second device 302 likewise sends a request for the social identity of the first device 300, and receives a corresponding response, as illustrated by optional actions 3:6 and 3:7. In this way, the user interface of device 302 can also be adapted in a corresponding manner based on the same trusted connection, which is however not described here further for simplicity.

Having obtained the social identity of the second device 302 in action 3:5, the first device 300 sends a request for profile information of device 302 to manager 304, here denoted “Get profile info of D2”, in a following action 3:8. The social network manager 304 responds by retrieving and sending the requested profile information of device 302 in a following action 3:9. Thus in this example, requesting the trusted connection and obtaining the profile information requires two requests from the device 300 and corresponding responses from the manager 304. Alternatively, it is also possible that only one request and a corresponding response are needed, e.g. an “explicit” request from device 300 for the trusted connection with device 302 and a response with the profile information of device 302 from the manager 304, depending on how the solution is implemented.

Having obtained the profile information of the second device 302 in action 3:9, the first device 300 is now able to adapt its user interface based on this profile information, in another action 3:10. Some examples of how the user interface can be adapted have been described above. Another practical example that might be mentioned here is when the first device comes into proximity of a vending machine, thus being the second device. If the above solution is accordingly applied, the first device may display a control panel associated with the vending machine, based on obtained profile information, which enables the first device user to purchase some item from the vending machine by making input commands to the control panel.

The following actions in FIG. 3 basically describe an example of how the solution may be utilized by interacting with the second device once the user interface of device 300 is adapted based on the profile information of device 302. Thus, in a further action 3:11, a user input is received at the device 300, e.g. on a displayed control panel or according to any other information or functionality provided by the adapted user interface. In response to this user input, the first device 300 sends an instruction, a request, or similar, for controlling a function in the second device 302 according to the user input, to the social network manager 304 in an action 3:12. Provided that the temporary trusted connection between devices 300 and 302 is still “alive” and not released, the social network manager 304 sends a corresponding control command to the second device 302 in an action 3:13. The second device 302 then basically executes the function according to the received command, in another action 3:14.

It is possible for the first device user to make any number of further user inputs to control functionality in the second device 302 in this way, as long as the temporary trusted connection is alive and valid. The first device may continually detect whether the second device is still within proximity by means of the wireless link. For example, the social network manager 304 may require regular refresh messages or the like from the first device in order to keep the trusted connection alive, otherwise it may be released, e.g. after a certain timeout period.

In this example, the first device 300 detects at some point later that it has lost contact with the second device 302 on the local wireless link, as schematically shown by an action 3:15. The first device 300 then sends a notification to the social network manager 304 accordingly, informing of the lost contact, in an action 3:16, and the social network manager 304 is thereby triggered to release the temporary trusted connection, in a final shown action 3:17.

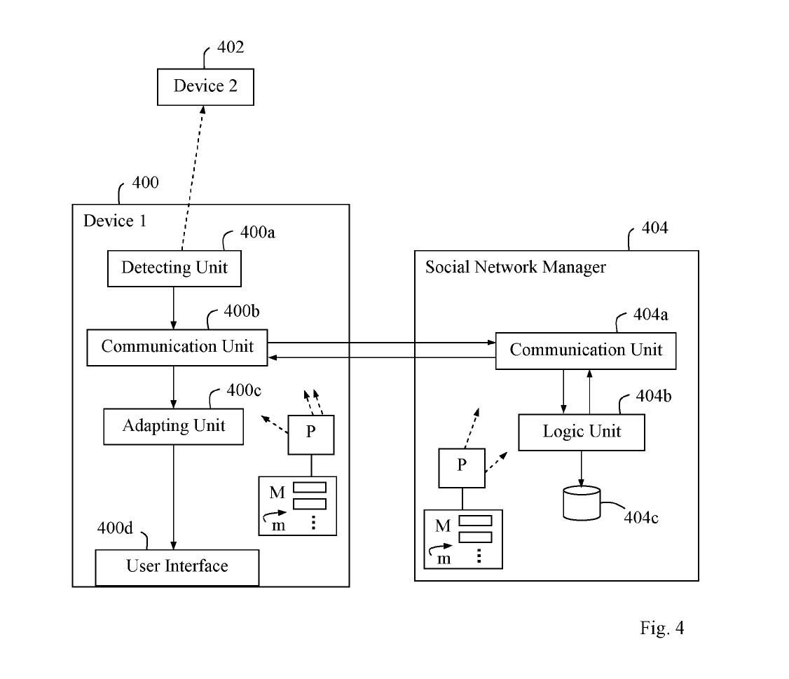

A detailed but non-limiting example of how a first device and a social network manager can be configured to accomplish the above-described solution, is illustrated by the block diagram in FIG. 4. The first device 400 is configured to enable interaction with a second device 402 for usage of functionality in the second device, while the social network manager 404 configured to enable interaction between the first and second devices 400, 402 for usage of functionality in the second device, e.g. according to the procedures described above for any of FIGS. 1-3, respectively. The first device 400 and the social network manager 404 will now be described in terms of a possible example of employing the solution. It is assumed that both devices 400, 402 have been registered in the manager 404 in the manner described above.

The first device 400 comprises a detecting unit 400a configured to detect proximity to other devices by means of a local wireless link, such as device 402 as schematically indicated by the dashed arrow. The first device 400 also comprises a communication unit 400b configured to send a request to the social network manager 404 to establish a temporary trusted connection with the second device 402, when the detecting unit 400a detects that the first device is present within a limited distance from the second device 402 that allows communication by means of a local wireless link. The communication unit 400b is further configured to obtain profile information regarding the second device from the social network manager 404 based on the temporary trusted connection.

The first device 400 further comprises an adapting unit 400c configured to adapt a user interface 400d of the first device based on the obtained profile information, thereby enabling a user of device 400 to execute the interaction between the first and second devices via the social network manager 404 by means of the adapted user interface 400d.

The above first device 400 and its functional units 400a-d may be configured or adapted to operate according to various optional embodiments. In a possible embodiment, the detecting unit 400a is further configured to detect proximity to other devices by means of a local wireless link based on any of: Bluetooth, RFID and NFC. In another example, the request to establish the temporary trusted connection with the second device may comprise a request for a social identity of the second device, and in that case the communication unit 400b may be further configured to obtain the profile information from the social network manager based on the social identity of the second device.

If the user interface comprises a screen, the adapting unit 400c may be further configured to adapt the user interface by displaying at least a part of the obtained profile information on the screen. The profile information may comprise a control panel that can be used to control functionality of the second device, and adapting the user interface may comprise displaying the control panel on the screen.

Further, the profile information may comprise a network address of a web page, and in that case the adapting unit 400c may be further configured to adapt the user interface of the user equipment by directing a web browser in the user equipment to use that web page as a start page in the user interface. When the detecting unit 400a detects that the local wireless link has been lost, the communication unit 400b may be further configured to send a notification to the social network manager to trigger release of the temporary trusted connection.

The social network manager 404 comprises a communication unit 404a configured to receive the request from the first device 400 to establish a temporary trusted connection with the second device 402, when the first device has detected to be present within a limited distance from the second device that allows communication by means of a local wireless link. The social network manager 404 also comprises a logic unit 404b configured to establish the temporary trusted connection between the first and second devices if the first and second devices have been registered with the social network manager, e.g. in a database 404c.

The communication unit 404a is further configured to send profile information regarding the second device to the first device 400 based on the temporary trusted connection, thereby enabling adaptation of the user interface 400d of the first device 400 based on the sent profile information, and further enabling a user to execute the interaction between the first and second devices via the social network manager 404 by means of the adapted user interface.

The above social network manager 404 and its functional units 404a-c may be configured or adapted to operate according to various optional embodiments. In a possible embodiment, the first and second devices have been registered with the social network manager by storing social identities of the first and second devices together with their profiles in the database 404c. In that case, the request to establish the temporary trusted connection with the second device may comprise a request for the social identity of the second device, and the communication unit 404a may be further configured to send the profile information to the first device in response to a profile request referring to the social identity of the second device.

In another example, the logic unit 404b may be further configured to release the temporary trusted connection when a notification is received from the first device indicating that the local wireless link has been lost.

It should be noted that FIG. 4 illustrates various functional units in the first device 400 and the social network manager 404 and the skilled person is able to implement these functional units in practice using suitable software and hardware means. Thus, this aspect of the solution is generally not limited to the shown structures of the first device 400 and the social network manager 404, and the functional units 400a-c and 404a-b may be configured to operate according to any of the features described in this disclosure, where appropriate.

The functional units 400a-c and 404a-b described above can be implemented in the first device 400 and the social network manager 404, respectively, by means of program modules of a respective computer program comprising code means which, when run by processors “P” causes the first device 400 and the social network manager 404 to perform the above-described actions. Each processor P may comprise a single Central Processing Unit (CPU), or could comprise two or more processing units. For example, each processor P may include general purpose microprocessors, instruction set processors and/or related chips sets and/or special purpose microprocessors such as Application Specific Integrated Circuits (ASICs). Each processor P may also comprise a storage for caching purposes.

Each computer program may be carried by a computer program product “M” in the first device 400 and the social network manager 404, respectively, in the form of a memory having a computer readable medium and being connected to the processor P. Each computer program product M or memory thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the first device 400 and the social network manager 404, respectively.

Some advantages that may be accomplished by the above-described solution include that the threshold perceived by users for making two closely located devices interact and to control and use functionality in one device from another device, is significantly reduced since no manual actions are needed from the device users for establishing a trusted connection that allows this interaction. Thereby, any spontaneous and/or temporary usage of functionality, e.g. offerings, in the second device can be stimulated and facilitated. This may in turn result in increased traffic and usage of services in the network and increased sales and revenue for network operators and service providers. It is a further advantage that in this solution the temporary trusted connection can easily be released automatically once the devices have moved away from one another, e.g. according to any of the examples described above. The solution also provides a simple mechanism and an opportunity to distribute potentially interesting and useful information and functionality to device users when entering a certain premises.

While the solution has been described with reference to specific exemplary embodiments, the description is generally only intended to illustrate the inventive concept and should not be taken as limiting the scope of the solution. For example, the terms “device”, “social network manager”, “social identity”, “device identification”, and “trusted connection” have been used throughout this description, although any other corresponding nodes, functions, and/or parameters could also be used having the features and characteristics described here. The solution is defined by the appended claims.

1-22. (canceled)

23. A method in a first device for enabling interaction with a second device for usage of functionality in the second device, the method comprising:
sending a request to a social network manager to establish a temporary trusted connection with the second device, when detecting that the first device is present within a limited distance from the second device that allows communication by means of a local wireless link;
obtaining profile information regarding the second device from the social network manager based on said temporary trusted connection; and
adapting a user interface of the first device based on the obtained profile information, thereby enabling a user to execute the interaction between the first and second devices via the social network manager by means of the adapted user interface.

24. The method of claim 23, wherein the local wireless link is based on any of: Bluetooth, radio-frequency (RFID), and near-field communications (NFC) technologies.

25. The method of claim 23, wherein the request to establish the temporary trusted connection with the second device comprises a request for a social identity of the second device, and wherein the profile information is obtained from the social network manager based on the social identity of the second device.

26. The method of claim 23, wherein the user interface comprises a screen and said user interface is adapted by displaying at least a part of the obtained profile information on the screen.

27. The method of claim 26, wherein said profile information comprises a control panel that can be used to control functionality of the second device, and adapting the user interface comprises displaying the control panel on the screen.

28. The method of claim 23, wherein said profile information comprises a network address of a web page, and said user interface of the user equipment is adapted by directing a web browser in the user equipment to use said web page as a start page in the user interface.

29. The method of claim 23, wherein a notification is sent to the social network manager when detecting that the local wireless link has been lost, to trigger release of said temporary trusted connection.

30. A first device configured to enable interaction with a second device for usage of functionality in the second device, comprising:
a detecting circuit configured to detect proximity to other devices;
a communication circuit configured to send a request to a social network manager to establish a temporary trusted connection with the second device, when the detecting unit detects that the first device is present within a limited distance from the second device that allows communication by means of a local wireless link, and further configured to obtain profile information regarding the second device from the social network manager based on said temporary trusted connection; and
an adapting circuit configured to adapt a user interface of the first device based on the obtained profile information, thereby enabling a user to execute the interaction between the first and second devices via the social network manager by means of the adapted user interface.

31. The first device of claim 30, wherein the detecting unit is further configured to detect proximity to other devices by means of a local wireless link based on any of: Bluetooth, radio-frequency (RFID), and near-field communications (NFC) technologies.

32. The first device of claim 30, wherein the request to establish the temporary trusted connection with the second device comprises a request for a social identity of the second device, and wherein the communication unit is further configured to obtain the profile information from the social network manager based on the social identity of the second device.

33. The first device of claim 30, wherein the user interface comprises a screen and the adapting unit is further configured to adapt the user interface by displaying at least a part of the obtained profile information on the screen.

34. The first device of claim 33, wherein said profile information comprises a control panel that can be used to control functionality of the second device, and adapting the user interface comprises displaying the control panel on the screen.

35. The first device of claim 30, wherein said profile information comprises a network address of a web page, and the adapting circuit is further configured to adapt said user interface of the user equipment by directing a web browser in the user equipment to use said web page as a start page in the user interface.

36. The first device of claim 30, wherein the communication circuit is further configured to send a notification to the social network manager when the detecting circuit detects that the local wireless link has been lost, to trigger release of said temporary trusted connection.

37. A method in a social network manager for enabling interaction between a first device and a second device for usage of functionality in the second device, the method comprising:
receiving a request from the first device to establish a temporary trusted connection with the second device, when the first device has detected to be present within a limited distance from the second device that allows communication by means of a local wireless link,
establishing a temporary trusted connection between the first and second devices if said first and second devices have been registered with the social network manager, and
sending profile information regarding the second device to the first device based on said temporary trusted connection, thereby enabling adaptation of a user interface of the first device based on the sent profile information, and further enabling a user to execute the interaction between the first and second devices via the social network manager by means of the adapted user interface.

38. The method of claim 37, wherein said first and second devices have been registered with the social network manager by storing social identities of the first and second devices together with their profiles in a database.

39. The method of claim 38, wherein the request to establish the temporary trusted connection with the second device comprises a request for the social identity of the second device, and wherein the profile information is sent to the first device in response to a profile request referring to the social identity of the second device.

40. The method of claim 37, wherein said temporary trusted connection is released when a notification is received from the first device indicating that the local wireless link has been lost.

41. A social network manager configured to enable interaction between a first device and a second device for usage of functionality in the second device, comprising:
a communication circuit configured to receive a request from the first device to establish a temporary trusted connection with the second device, when the first device has detected to be present within a limited distance from the second device that allows communication by means of a local wireless link, and
a logic circuit configured to establish a temporary trusted connection between the first and second devices if said first and second devices have been registered with the social network manager,
wherein the communication circuit is further configured to send profile information regarding the second device to the first device based on said temporary trusted connection, thereby enabling adaptation of a user interface of the first device based on the sent profile information, and further enabling a user to execute the interaction between the first and second devices via the social network manager by means of the adapted user interface.

42. A social network manager of claim 41, wherein said first and second devices have been registered with the social network manager by storing social identities of the first and second devices together with their profiles in a database.

43. A social network manager of claim 42, wherein the request to establish the temporary trusted connection with the second device comprises a request for the social identity of the second device, and wherein the communication circuit is further configured to send the profile information to the first device in response to a profile request referring to the social identity of the second device.

44. A social network manager of claim 41, wherein the logic circuit is further configured to release said temporary trusted connection when a notification is received from the first device indicating that the local wireless link has been lost.
